(19) United States
(12) Patent Application Publication
(10) Pub. No.: US 2025/0002754 A1
(43) Pub. Date: Jan. 2, 2025

(54) MOLDING OR COATING CONSISTING OF A DIETARY FIBER FRACTION FROM MACAUBA PULP, AND METHOD OF PRODUCING THE FRACTION

(71) Applicants: Fraunhofer-Gesellschaft zur Foerderung der angewandten Forschung e.V., Muenchen (DE); Instituto de Tecnologia de Alimentos (ITAL), Chacaras (BR); Instituto Agronomico Campinas IAC, Botafogo, Campinas (SP) (BR)

(72) Inventors: Sérgio Henrique TOLEDO E SILVA, Chácaras Campos dos Amarais (BR); Gabriele DOER, Freising (DE); Peter EISNER, Freising (DE); Stephanie MITTERMAIER, Freising (DE); Isabel MURANYI, Freising (DE); Roseli APARECIDA FERRARI, Chácaras Campos dos Amarais (BR); Alexandre MARTINS MOREIRA, Chácaras Campos dos Amarais (BR); Lidiane BATAGLIA DA SILVA, Chácaras Campos dos Amarais (BR); Carlos COLOMBO, Chácaras Campos dos Amarais (BR)

(21) Appl. No.: 18/575,409

(22) PCT Filed: Jun. 28, 2022
(86) PCT No.: PCT/EP2022/067709

§ 371 Date: Dec. 29, 2023

(30) Foreign Application Priority Data
Jun. 30, 2021 (DE) 10 2021 116 923.2

(51) Int. Cl. C09D 197/02; C08H 8/00; C08L 97/02

(52) U.S. Cl. CPC C09D 197/02; C08H 8/00; C08L 97/02

(57) ABSTRACT

The invention relates to a moulding or a coating which contains at least one biopolymer or is made from at least one biopolymer. The biopolymer is a dietary fibre preparation which is produced from the flesh of the macauba fruit and has a dietary fibre content of more than 30% by mass, preferably more than 35% by mass, and a fat content of less than 8% by mass. This Biopolymer is suitable as a fully functional substitute for petroleum-based polymers and is at the same time biodegradable.

### FIELD OF APPLICATION

The invention relates to mouldings or coatings which contain biobased and mostly or entirely biodegradable polymer materials from components of macauba pulp, and a method for producing the biopolymers.

### PRIOR ART

Driven by the increasingly intense effects of climate change and the limited availability of fossil resources, the demand for plant-based and biodegradable plastics continues to grow. Particularly in the field of packaging materials with applications such as films, blisters, bowls, stand-up pouches and bottles, but also in the field of technical components, the search for alternatives to petroleum-based plastics is gaining momentum. But particularly in the packaging sector, the standards governing the material properties of packaging films, for example, are extremely stringent. In many cases, these properties are subject to strict requirements regarding their flexibility, tensile, compressive and flexural strength as well as the light, water vapour and oxygen barrier in order to protect the packaged goods, and at the same time the materials are expected to meet requirements in terms of contact with food. These stringent technological demands in combination with the biogenic origin of the raw materials and biodegradability of the polymers are not satisfied by the materials of the prior art.

Known biopolymers include those based on carbohydrates such as cellulose or starch. Cellulose can serve as the basis for obtaining materials such as viscose, cellophane or celluloid, and others, but these entail the use of large amounts of chemicals, auxiliary materials and energy for their production, so they cannot be described as sustainable. On the other hand, polymers from starch have a brittle structure and need large quantities of plasticisers before they can be used in flexible applications. However, in many cases said plasticisers are not suitable for applications which entail contact with sensitive filling materials, such as foodstuffs and they also cause changes in the barrier properties of the respective biopolymer.

Also known are biopolymers produced by fermentation processes, such as polylactic acid (PLA) or polyhydroxybutyrate (PHB). Both polymers are of natural origin and have good to very good biodegradability, but under certain circumstances they are very brittle and must be combined with additives such as plasticisers for flexible application, which again can impair the barrier properties.

Accordingly, it has been found that biopolymers are not very suitable, or entirely unsuitable as substitutes for fossil plastics in most applications without expensive use of additives or modification.

There is practically no information in the prior art about the suitability of macauba pulp for applications as a bio-polymer. Biobased films produced from partially de-oiled macauba pulp have been written about by da Silva et al. [1]. In this study, pulp was first obtained from fruits of the macauba palm, sorted by colour, sterilised with hydrochloric acid, de-oiled to obtain an oil fraction of 8.5% by mass, the resulting flour was dispersed in water, glycerin as plasticiser and clove oil were added, and the mixture was then poured into petri dishes and dried to produce films. The films were yellowish in colour and non-transparent. These properties are undesirable for many films. These films were unsuitable for technical applications due to their high plasticiser content and low strength.

A review of the prior art reveals that there are as yet no good biobased polymers for flexible applications, and that at present it is still not possible to process macauba pulp fractions to obtain polymer materials that are suitable for use as full-featured substitutes for petroleum-based polymers and at the same time are biodegradable. Furthermore, most biopolymers according to the prior art are very brittle, and plasticisers are therefore need in many applications.

### OBJECT OF THE PRESENT INVENTION

It was the object of the present invention to provide mouldings or coatings containing biopolymers that can be used as a substitute for petroleum-based plastics, for packaging films or injection moulded parts, for example, and which do not have the existing disadvantages of the prior art. It is further intended to describe a method for producing said biopolymers.

### DESCRIPTION OF THE INVENTION

The object is solved with a moulding or coating that contains at least one dietary fibre preparation of macauba pulp, and with a method for producing the preparation according to Claims 1 and 18. Advantageous variants of the moulding or coating and of the method are the object of the dependent claims, or may be discerned from the following description and the exemplary embodiments.

The moulding may be for example a film, an injection moulded part or a blown hollow body, the coating may be for example a varnish, a film, or other variations. In the following text, the expression “biopolymer film” will be used to represent all implementations, including coatings, although the moulding according to the invention may generally have any form and originate from any primary shaping process, such as injection moulding, extruding, calendaring, rotational moulding, foaming, casting or blow moulding. The dietary fibre preparation may be implemented as a monomaterial or as an addition to a material mixture or as a coating on other materials.

The dietary fibre preparation preferably constitutes the main component of the moulding or coating, which means that it is present in the moulding or coating in a fraction by volume or a fraction by mass of more than 50%. The fraction by mass of the dietary fibre preparation in the moulding or coating is particularly preferably at least 75% by mass.

In the following text, the percentage values of the fractions and dietary fibre preparations of the biopolymer film originating from the macauba pulp refer solely to the fractions of the corresponding component in the macauba fraction, and with the exception of the water content are indicated relative to the dry matter. Further components and additives in the biopolymer film such as for example filler materials, dyes, plasticisers, UV stabilisers, anti-friction agents and others are not included in the percentages, so that, unless explicitly stated otherwise, the percentages indicated refer purely to the respective macauba ingredients.

In the context of the present invention, it was recognised that residues which are obtained when recovering vegetable oil from the pulp of macauba fruits can be processed particularly advantageously to produce biopolymer films or can be added to such films if the oil content in the residue is minimised and the dietary fibre content increased. In this case, the functional and barrier properties of the biopolymer film are optimal when the oil content is reduced to significantly below 5% by mass, and at the same time the alcohol-water-soluble substances (AWS) are mostly separated from the dietary fibre materials that are left in the form of raffinate upon extraction.

In the present patent application, the concept of dietary fibre is based on the comprehensive definition thereof by the CODEX Alimentarius as carbohydrate polymers that are not hydrolysed by the endogenous enzymes in the human small intestine. In particular, in the present patent application the term dietary fibres refers mainly to polysaccharides of the plant cell wall (including cellulose, hemicelluloses, gum and pectins) and lignin, which are resistant to hydrolysis by digestive enzymes and are precipitated in aqueous ethanolic solutions in a concentration of the same concentration or higher than 78% (v/v). The dietary fibre content is determined in the present patent application using the official method of the ASSOCIATION OF OFFICIAL ANALYTICAL CHEMISTS (AOAC International), based on the gravimetric assay after digestion of the sample with digestive enzymes, in particular α-amylase, protease and amyloglucosidase (reference method 991.43 from AOAC International).

For the purpose of the following text, alcohol-water soluble substances are understood to be all compounds which are soluble in ethanol-water mixtures with a fraction by mass of 80% ethanol at a temperature of 80° C. Besides other soluble compounds in the fruit, these are in particulars the plant's natural sugars, including mono-, di- and oligosaccharides.

It is also possible to combine several fractions from the macauba fruit.

The at least one dietary fibre preparation is characterized according to the invention in that its fat content is less than 8% by mass, better less than 5% by mass, advantageously less than 2% by mass, particularly advantageously less than 1% by mass, and that its dietary fibre content is more than 30% by mass, better more than 35% by mass, better still more than 40% by mass, advantageously more than 50% by mass or more than 60% by mass, particularly advantageously more than 70% by mass, better more than 80% by mass, optimally more than 90% by mass. With fat contents less than 2% by mass in the dietary fibre preparation, the biopolymer film displays particularly good colour properties. The film is either transparent or opaque and very pale and has a brightness (L*-value) of more than 70, advantageously more than 80, particularly advantageously more than 90.

High dietary fibre values of more than 70% by mass can be achieved if the fat content is lowered by extraction to values below 8, better below 5% by mass, and at the same time the content of alcohol-water soluble substances is reduced by dry fractionation and/or extraction to values less than 20% by mass, better less than 15% by mass, better still less than 10% by mass.

In some variants, it may be advantageous for obtaining a necessary strength of the biopolymer film if the content of alcohol-water soluble substances is reduced substantially. This is done according to the invention in absolute % by mass points at least to such an extent that the total of alcohol-water soluble substances and oil is below 61% by mass, advantageously below 55% by mass, particularly advantageously below 50% by mass. Consequently, the dietary fibre content is increased to such a degree that a stable matrix of dietary fibres can form in the biopolymer film, which is sufficient to lend the biopolymer film enough strength for it to be used for simple applications, for example as biodegradable agricultural film or secondary packaging for fruit.

In tensile tests with the biopolymer film it was found that with oil contents less than 8% by mass, but particularly less than 5% by mass, significant increases in strength are obtained the further the oil content is reduced. The greatest strengths are achieved with oil contents below 1% by mass.

Surprisingly, some particularly highly concentrated dietary fibre fractions from the macauba pulp may be used even without the addition of plasticisers to produce transparent biopolymer films that are extremely flexible, reversibly deformable, and include a barrier, which allows their use as packaging film for food, for example. The water-soluble dietary fibre fraction (1) from macauba pulp, which after implementation of the method according to the invention has a dietary fibre percentage of more than 70% by mass in the macauba fraction (any additives included for the production of the film are not included in this figure) is particularly suitable for this.

The use of macauba biopolymer films according to the invention may be used particularly advantageously for applications entailing direct contact with foodstuffs (packaging, food coatings and coverings to preserve freshness), as macauba dietary fibres are usable as food ingredients and consequently can be used for edible packagings or food coatings without approval procedures.

It has further been found that the natural biopolymer film can easily be combined with other organic and/or inorganic layers in such a way that exceptionally good barrier properties are obtained despite their great flexibility. If materials of natural origin (biopolymers) or consisting of purely inorganic components such as SiOx for example are used for the barrier layers, films can be prepared that are free of fossil-based components and are completely biodegradable, leaving only environmentally neutral inorganic residues. In this way, flexible, functional and environmentally entirely neutral biopolymer films can be produced from native components of the macauba pulp, without chemical modification, solely by implementing simple concentration methods, which films may then be used as substitute for petroleum based plastics in an enormous variety of applications.

In an advantageous variant of the biopolymer film according to the invention, further components of the pulp that are not water-soluble and which can reduce the flexibility of the biopolymer film are also included in addition to the water-soluble, transparent dietary fibre fraction. But surprisingly, up to 70% water-insoluble dietary fibres (incl. pectin) can be successfully introduced into the biopolymer film without impairing the functional characteristics. However, it may be necessary to include further additives, such as plasticisers for example, given such high concentrations of insoluble components.

In an advantageous variant of the biopolymer film according to the invention, the film is spread as a coating on a composite containing paper or cardboard to obtain a smoother surface and an even coating, for example to enable the application of further (e.g., inorganic) barrier layers. In coatings of paper and cardboard a fraction as small as 10% by mass of the dietary fibre or the macauba fraction relative to the total mass, consisting of the mass of the macauba fraction plus the mass of the paper/cardboard, may produce highly advantageous smoothing effects for the paper/cardboard surface. A greater mass fraction of macauba coating of more than 20% by mass, better more than 30% by mass results in a further reduction of the surface roughness.

In some cases, it may be beneficial, and even necessary in order to satisfy defined requirements regarding the biopolymer film, to include other additives in the biopolymer film as well as the macauba fraction, in order to increase its stretchability, for example, or to integrate a light filter in the film. These are advantageously selected from the group of biogenic raw materials. In the case of plasticisers, these may be for example natural compounds such as glycerin, for example, or secondary plant substances such as polyphenols, carotenoids, chlorophyll or others may be used as UV or light filters or stabilisers. Plant substances such as insoluble fibres for example will preferably also be used besides inorganic components such as SiOx in coating materials as barrier or in filler materials. In this way, the advantageous environmental neutrality of the biopolymer film is maintained.

Various methods may be used for shaping the biopolymer film. The moist or dried biopolymer film components obtained from the macauba pulp are advantageously mixed with water or dispersed in water before the application. Direct processing of the fractions that are extracted with water (without removal of the water or drying in between) is also possible. Then, films are poured and these are dried. It is also possible to mix the mixture of macauba pulp components with or without the addition of water or other flow agents using an extruder and to inject it into moulds or shape it into films and separate the water—if present—by vaporisation or evaporation.

### Macauba Fraction for the Biopolymer Film

As was noted previously, the biopolymer film according to the invention contains at least one a fraction from macauba pulp as a component, or it consists entirely of at least one fraction from macauba pulp. This fraction will be described in the following text.

The fraction according to the invention may be present in any proportions, dissolved or dispersed in water. Thus, the water content may vary between 99.9% by mass and 0.1% by mass, for the application as cast film, for example, it will be more than 90% by mass, for secure storage of the fraction a water content less than 10% by mass is selected.

The macauba fraction has a fat content of less than 8% by mass, better less than 5% by mass, advantageously less than 2% by mass, particularly advantageously less than 1% by mass in the dry matter. The percentage of dietary fibres in the fraction is more than 30% by mass, better more than 35% by mass, better still more than 40% by mass, advantageously more than 50% by mass or more than 60% by mass, particularly advantageously more than 70% by mass, better more than 80% by mass, optimally more than 90% by mass.

High values of over 70% by mass dietary fibres in fraction can be attained if the fat content is reduced by extraction to values below 8, better below 5% by mass, and at the same time the content of alcohol-water soluble substances is reduced by dry fractionation and/or extraction to values less than 20% by mass, better less than 15% by mass, better still less than 10% by mass. The procedure for obtaining compositions of such kind is described in the method according to the invention.

The content of alcohol-water soluble substances is advantageously less than 46% by mass to 53% by mass. The actual limits are determined from the sum of the fat percentage and the fat plus AWS percentage. In total, the macauba fraction according to the invention will contain of percentage of fat plus AWS that is less than 61% by mass, advantageously less than 55% by mass, particularly advantageously less than 50% by mass. From this limit, which can easily be adjusted in the method, a dietary fibre content is obtained which is sufficient to the lend the biopolymer film according to the invention adequate strength.

The macauba fraction used preferably has a shell content of less than 10% by mass, better less than 5% by mass, preferably less than 2% by mass, relative to the dry matter.

The properties of the macauba fraction may be further improved for forming a flexible biopolymer film with good tensile strength if the particle size distribution of the macauba particles contained are in particularly fine condition before their use in the biopolymer film—for example by crushing or homogenising. The macauba fraction can be processed and cross-linked particularly readily if the particles present have a D₉₀ particle size less than 1 mm (D₉₀ value: 90% of the volume of the particles are less than 1 mm), better less than 500 μm, better still less than 250 μm, advantageously less than 100 μm, particularly advantageously less than 50 μm. Portions of an aqueous macauba fraction in solution, e.g., sugars or other soluble components are not detected in this measurement. With this particle size distribution, a biopolymer film with very low thickness can be designed without the solids in the film causing unevennesses.

In particularly advantageous variants of the invention, the macauba fraction may be present in various compositions, which have different processing characteristics. It has been found that the water-soluble component of the macauba fraction is able to form particularly strong films. Accordingly, it is advantageous to prepare it separately. This can be done by fractionating the residue into as many as six further fractions after the oil and the AWS are separated from the macauba pulp, whereby particularly functional macauba fractions for the production of biopolymer films are obtained. These are: (1) a water-soluble fraction (soluble in water between 5 and 100° C.) and a water-insoluble residual fraction (2). The fraction (2) can be separated into a second soluble pectin fraction (3) and an insoluble fraction (4) with the aid of an alkaline and chelating extraction milieu. For this, 0.05-0.1 mol/L NaOH or sodium carbonate are used to assure a mild alkaline state, and 0.5 mmol EDTA or CDTA or 0.5% (m/v) ammonium oxalate for the chelating activity.

The fraction (4) can in turn be fractionated into a soluble hemicellulose fraction (5) and an insoluble cellulose-rich residue (6) with the aid of a concentrated potassium hydroxide solution (1-4 mol/L), optionally with the addition of 10 to 50 mmol sodium borohydride.

All of these fractions manifest quite different properties in biopolymer films. Thus for example, fraction (1) is particularly transparent and very readily soluble in water, and can be used as a grand matrix for a polymer film or a polymer component, whereas the other fractions may advantageously be used as filler materials with differing barrier or strength properties.

Depending on its preparation, the composition of fraction (1) is preferably as follows:
percentage of water-soluble dietary fibres from macauba pulp more than 50% by mass, better more than 60% by mass, better still more than 70% by mass, advantageously more than 80% by mass, particularly advantageously more than 90% by mass;
fat content less than 20% by mass, preferably less than 8% by mass, particularly preferably less than 5% by mass;
percentage of alcohol-water soluble substances less than 20% by mass, preferably less than 15% by mass, better less than 10% by mass.

Depending on their preparation, the composition of fractions (2) to (6) may be characterized as follows:
percentage of water-insoluble dietary fibres from macauba pulp more than 50% by mass, better more than 60% by mass, better still more than 70% by mass, advantageously more than 80% by mass, particularly advantageously more than 90% by mass.

### Method for Producing the Macauba Fraction for the Biopolymer Film

In the following text, the method according to the invention for producing the macauba fraction (dietary fibre preparation) will be described. The method includes at least the following steps:
Providing full fat or partially de-oiled pulp from macauba fruits with a fat content between 3% by mass and 60% by mass relative to dry matter. The fat contents of the full-fat pulp or the partially de-oiled pulp may vary depending on plant species or time of harvest, or they may differ as a consequence of their pretreatment (e.g., pre-pressing, drying, flaking, mechanical pressing, other conventional methods for recovering vegetable oil).
Reducing the fat content in the pulp to values (in dry matter) less than 8% by mass, particularly advantageously less than 5% by mass, better still less than 2% by mass, particularly advantageously less than 1% by mass with the aid of extraction methods.
Optionally: Reducing the content of alcohol-water soluble substances in the macauba fraction to values that result in in the total of alcohol-water soluble substances plus fat is less than 61% by mass, advantageously less than 55% by mass, particularly advantageously less than 50% by mass, with the aid of a dry fractionation or extraction method. In the case of dry fractionation, a grinding and sifting apparatus or similar may be used. For the extraction, solid-liquid extraction methods are used (e.g., in the form of mixer reactor, percolation, counterflow extraction, etc.).

### Optionally and Advantageously

Reduction of the oil content with the aid of solvents. The following are examples of possible solvents in this context: hexane, ethanol, propanol, supercritical CO₂ or other sub- or supercritical solvents and other organic solvents.
Use of mixtures of ethanol and water in a mass ratio from 94:6 to 90:10 at temperatures from 40-70° C., advantageously 50-65° C. for the simultaneous separation of oil and soluble substances from the macauba pulp.
Further reduction of the oil content and reduction of the content of alcohol-water soluble substances in the pulp by using water or mixtures of alcohol and water in a mass ratio less than 90:10, better less than 80:20 to recover the macauba fraction. In this context, propanol or ethanol preferably serve as the alcohol, with a temperature between 50 and 90° C., advantageously between 50 and 70° C., particularly advantageously at 60° C., so that dissolving of alcohol-insoluble carbohydrates is largely avoided.
Fractionating the water-soluble dietary fibre fraction from the alcohol-water soluble substances in the following steps:
   Extracting the pulp using a mixture of alcohol and water to separate alcohol-water soluble substances from the water-soluble dietary fibres, separating the sugar-containing extract from the raffinate, optionally in several consecutive stages, and then extracting the raffinate with water, preferably at temperatures above 30° C., more preferably above 40° C., to recover the water-soluble dietary fibre fraction, and/or
   Extracting all sugars and water-soluble dietary fibres with water, preferably at temperatures above 30° C., more preferably above 40° C., separating the extract from the raffinate; followed by separation of the extract into a fraction which is readily soluble in alcohol-water mixtures and a fraction which is not readily soluble in alcohol-water mixtures by ultrafiltration or alcohol precipitation of carbohydrates that are insoluble in alcohol-water mixtures, or
   Fractionating the water-soluble dietary fibres by dry fractionation. The concentrate is optionally ground (cutting mill, ball mill, impact mill or jet mill) to a D90 volume particle size of less than 2 mm, advantageously less than 500 μm, better less than 250 μm, particularly advantageously less than 100 μm, or it undergoes further processing without grinding. The material is then sifted with sieve opening diameters from 2 mm to 50 μm with 1 to 10 different sieves. Air separation may be carried out using various air separation methods, such as gravitational counterflow, gravitational cross flow, centrifugal counterflow and centrifugal crossflow. The water-soluble and water-insoluble fibres present in the dry state are separated into various fractions thereby.
Fractionating the dietary fibres, preferably after de-oiling to less than 5% by mass and/or substantial reduction of the alcohol-water soluble substances by aqueous extraction at 40° C., by means of: Separating an aqueous extract from a raffinate and preferably drying the water-soluble fraction (1), extracting the raffinate (fraction 2) using NaOH-EDTA solution with 0.05-0.1 mol/L NaOH or sodium carbonate and 0.5 mmol EDTA or CDTA or 0.5% (m/v) ammonium oxalate solution, and separating and drying the soluble fraction (3) from an insoluble raffinate (fraction 4), and finally extracting with concentrated alkali (1-4 mol/L), e.g. potassium hydroxide solution, and separating, neutralising and drying the extract (fraction 5) form the insoluble residue (fraction 6).

If these 6 fractions are dried after the drying step, their properties may be improved further still by mechanical means if the particle size distribution of the macauba fraction is adjusted to a certain range by grinding in a cutting mill, beater mill, ball mill or impact mill combined with the use of sieves and sieve inserts.

After the macauba fraction has been treated with solvents, the solvent content must be reduced. This entails temperatures from 25 up to 120° C., preferably more than 80° C., advantageously more than 100° C., and pressures less than 1 bar, advantageously less than 500 mbar, particularly advantageously less than 200 mbar.

Surprisingly, macauba fractions that still contain a small quantity of solvent such as hexane or alcohol have advantages in terms of solubility and other functional properties compared with solvent-free preparations. In an advantageous variant, the preparation therefore contains organic solvents in the range from 1 to 8000 ppm, advantageously between 10 and 100 ppm.

The following section describes how the full-fat or partially de-oiled pulp may be made available. After the macauba fruits have ripened, they are advantageously separated gently from the fruit cluster, ideally at different times depending on the degree of ripeness. The quality of both the oil and the pulp is best if individual fruits are harvested separately from the fruit clusters. It is also possible to cut the entire fruit clusters from the palm. Then, the falling fruit cluster should advantageously be caught softly, e.g., with a soft foil or soft net, or some other system for gently breaking the fall, in order to avoid damaging the outer shell.

Before the further mechanical processing of the fruits, the surface of the fruits should advantageously undergo heat treatment, to a surface temperature above 70° C., advantageously above 75° C., particularly advantageously above 80° C. for at least 1 minute (definition of the duration: from the time the maximum temperature is reached until the temperature falls below 65° C.), advantageously longer than 10 minutes or 20 minutes, particularly advantageously longer than 30 minutes.

After this, the water content of the outer shell should advantageously be reduced to a value less than 20% by mass, advantageously less than 10% by mass, to enable efficient shelling and reduce the amount of pulp in the shell fraction.

Any known form of drying can be used in this context. The person skilled in the art will be able to select the suitable method from the many possible drying methods depending on the desired quality of the oil and the intended drying rate—from drying in the open air or sun-drying, in a ventilated or unventilated hall, or a simple circulating air dryer, contact or convection dryer, or any other means up to vacuum drying.

It has been found to be particularly advantageous for high oil quality if not only the shell is dried, but the water content in the entire fruit is also lowered to a value less than 20% by mass, advantageously less than 15% by mass, particularly advantageously less than 10% by mass. Particularly after extensive drying to values less than 10% by mass, the fruits can be kept for longer, and the quality of the oil is improved.

After the drying and optional interim storage, the epicarp is shelled in a shelling device according to the state of the art. It should be ensured here that the parameters should be chosen such that less than 20% by mass pulp is left in the epicarp fraction, advantageously less than 10% by mass, particularly advantageously less than 5% by mass relative to the mass of the shell fraction. It is not possible to achieve this in one pass, a subsequent step of separating epicarp from pulp must be provided.

As a result of the shelling, it must further be ensured that after shelling only very small quantities of shell or no shell at all is included in the pulp fraction. Shelling must therefore be carried out in such manner that the separated pulp finally has a shell content of less than 10%, better less than 5%, preferably less than 2% by mass, relative to the dry matter. The person skilled in the art of fractionating plant raw materials will be able to select the appropriate equipment and process parameters for this separation task.

In the following step, the pulp is separated from the inner, hard shell of the drupe kernel, the endocarp. This can be carried out with cutting mills or other machines, which are known to the person skilled in the art. For reasons relating to the sensory appeal of the preparations according to the invention, this process will advantageously be designed in such manner that the content of pieces from the black endocarp in the pulp is less than 3% by mass, advantageously less than 1% by mass, particularly advantageously less than 0.1% by mass. The pulp obtained thereby is introduced into the method according to the invention. A further pretreatment may consist in a partial de-oiling. As a result of the special separation of quantities of the endocarp from the pulp, the oils obtained thereafter by mechanical or extraction means have a particularly low content of lignin or other phenolic component, and the taste of the oil is consequently more neutral.

The mechanical de-oiling will be carried out after separation of the water from the pulp by drying to values less than 30% by mass, better less than 20% by mass, advantageously less than 15% by mass, particularly advantageously less than 10% by mass, advantageously in a continuously operating press, e.g., a screw press, an extruder or another mechanical pressing apparatus. In this process, the oil content will advantageously be reduced to less than 30% by mass, particularly advantageously less than 20% by mass, or less than 15% by mass. Particularly advantageous technofunctional properties of the dietary fibre preparations according to the invention are obtained if the oil content after the mechanical de-oiling is between 15 and 25% by mass, since heat damage due to excessive friction can thus be avoided.

The following text is a brief description of the analytical methods used for the quantitative characterization of the dietary fibre preparations produced:

### Dietary Fibre Content

The dietary fibre content is defined as the content derived from the gravimetric determination method after enzymatic digestion of the sample (AOAC method 991.43) [2].

### Protein Content

The protein content is defined as the content calculated by determining the nitrogen in a sample and multiplying the value thus determined by the factor 6.25. In the present patent application, the protein content is expressed as a percentage relative to the dry matter. Reference methods for determining the protein content are the Dumas combustion method [3] and the Kjeldahl digestion method [4].

### Colour

The perceptible colour is defined by CIE-L*a*b* colorimetry (see DIN 6417). The L* axis indicates brightness, wherein black has the value 0 and white the value 100, the a* axis describes the green or red component, and the b* axis describes the blue or yellow component. The particle size of the sample must have a D90 value less than 100 μm.

### Fat Content

The fat content is determined gravimetrically with the Sohxlet method [5] (AOAC method 920.39).

### Water Content

The water content is determined gravimetrically according to § 64 LFGB methods [6] at 105° C. until constant weight is reached.

### AWS (Alcohol-Water Soluble Substances)

The content of alcohol-water soluble substances is determined as follows: The sample (macauba fraction) is dispersed in aqueous ethanol 80% (v/v) in a solid-liquid ratio of 1:10 (m/v). The dispersion is maintained at boiling temperature (about 80° C.) while stirred gently for 60 minutes. The mixture is then centrifuged (3300 g, 20 min, 20 oC) and filtered, and the supernatant (liquid phase) is retained. The solid pellet is extracted with 80% aqueous ethanol under similar conditions to those described above, until a clear extract is obtained (at least 5 extraction cycles). After the extraction cycles have been completed, the liquid extracts are combined, the ethanol is distilled and the water is evaporated overnight at 105° C. The solid quantity that remains after drying is weighed and recorded as a percentage of the sample quantity that underwent extraction at the start of the analysis.

### Exemplary Embodiments

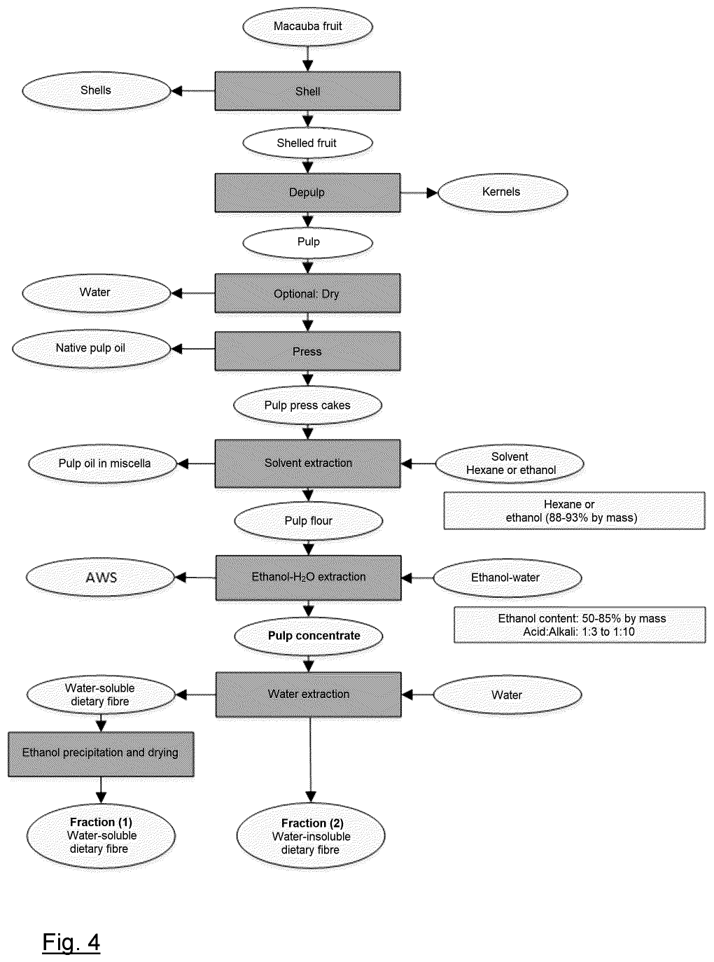

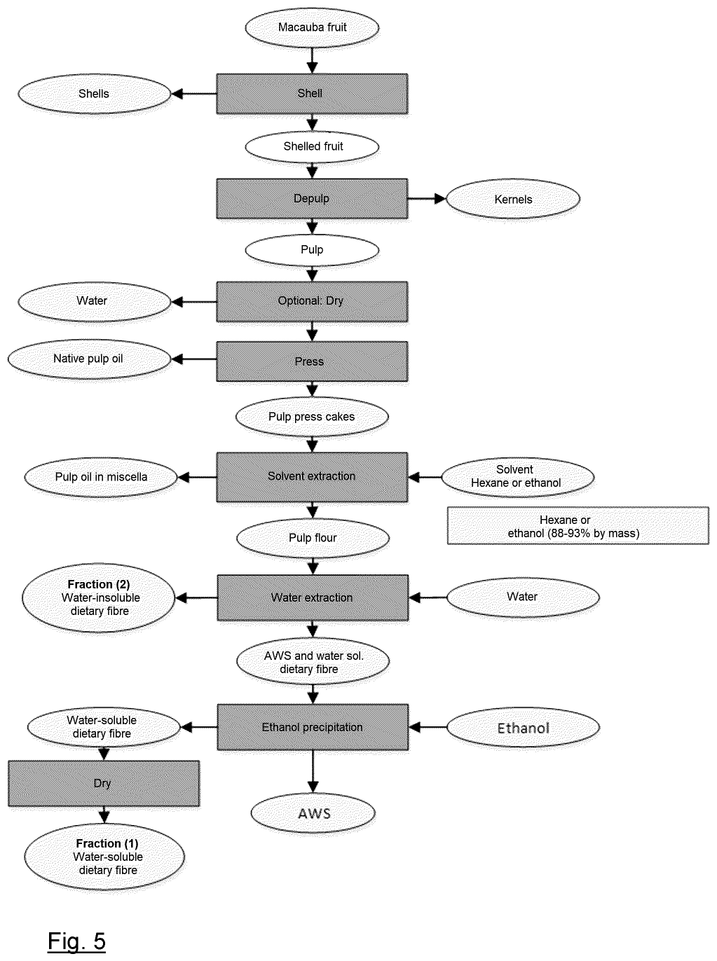

FIGS. 4 and 5 show two exemplary variants of methods for producing the dietary fibre preparations used as biopolymer, wherein in these examples the steps for obtaining the pulp are also shown.

### Exemplary Embodiment 1

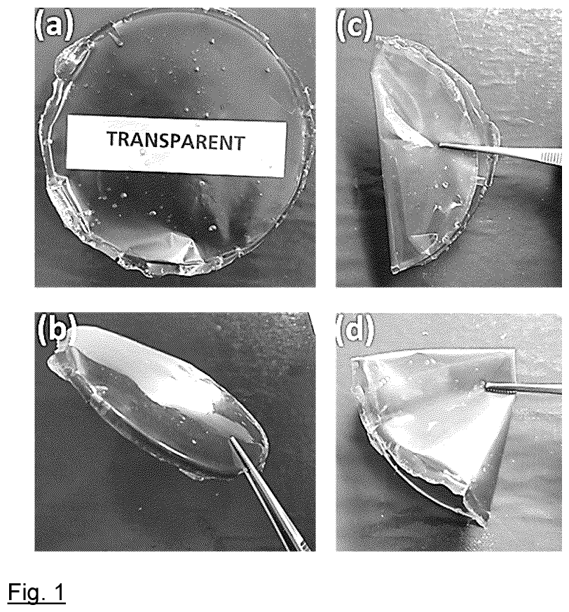

The film-forming property of the water-soluble fraction (1) extracted with water was evaluated qualitatively. For this purpose, 20 g of a 2.5% aqueous solution of the water-soluble fraction was poured into a petri dish (diameter 9 cm) with no added plasticisers. The solution was then dried in an oven with air circulation overnight at 25° C. The film obtained was easily detachable from the petri dish and reversibly mouldable, as is shown in FIG. 1. The water-soluble film had good flexibility properties and particularly good strength in the tensile test without significant stretching, also due to the fact that no plasticisers or crosslinking agents were used.

### Exemplary Embodiment 2

The film-forming property of the dietary fibre preparation was evaluated. The preparation has a dietary fibre content of 40.5%, a fat content of 3% and a AWS content of 35%. For this, 30 g of a 1.5% (m/v) aqueous solution of the dietary fibre preparation with 0.5% (m/v) glycerin added was poured into a petri dish (diameter 9 cm). The solution was then dried overnight in a circulating air oven at 25° C. The film obtained was easily detachable from the petri dish and reversibly mouldable, as is shown in FIG. 2. The water-soluble film had good flexibility properties and particularly good strength in the tensile test without significant stretching, although the films were less transparent than the film presented in Exemplary embodiment 1.

### Exemplary Embodiment 3

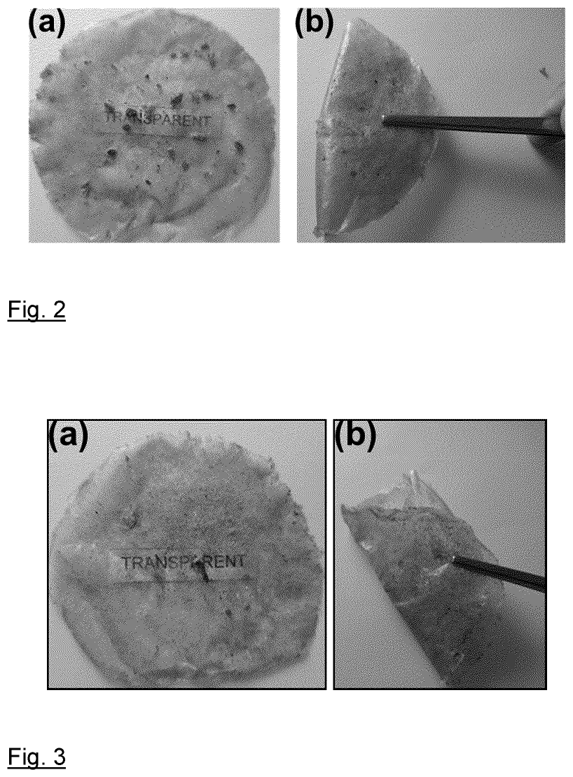

The film-forming property of the dietary fibre preparation was evaluated. The pre preparation had a dietary fibre content of 80.5%, a fat content of less than 0.5% and a AWS content of 10%. For this, 30 g of a 1.5% (m/v) aqueous solution of the dietary fibre preparation with 0.5% (m/v) glycerin added was poured into a petri dish (diameter 9 cm). The solution was then dried overnight in a circulating air oven at 25° C. The film obtained was easily detachable from the petri dish and reversibly mouldable (see FIG. 3). The water-soluble film had good flexibility properties and particularly good strength in the tensile test without significant stretching, although the films were less transparent than the film presented in Exemplary embodiment 1

### Exemplary Embodiment 4

The film-forming property of the water-soluble fraction (1) extracted with water was evaluated by extrusion. For this purpose 55% of the water-soluble fraction (1) was mixed with 20% water and 25% glycerin, and stored overnight for equilibration. The film was extruded in a twin screw extruder at temperatures of 45, 120, 120 and 120° C. in the feed, metering, compression and die areas of the extruder. The film was extruded with a screw speed of 50 rpm and processed to produce panels. The films were deformed with a 100 mm wide belt nozzle and then passed through a film take-off apparatus. The film obtained had a thickness of 0.5 mm, good mechanical resistance and satisfactory oxygen barrier characteristics.

### Exemplary Embodiment 5

The thermoplastic properties of the dietary fibre preparation were evaluated for the production of biodegradable bioplastics. The dietary fibre preparation had a dietary fibre content von 70.5%, a fat content of less than 0.5%, and a AWS content of 20%. The composite substance was formulated with 70% dietary fibre preparation, 18% glycerin and 12% water. The dietary fibre preparation was mixed with glycerin at high speed (2500 rpm) for 5 minutes. Water was then added, and mixing continued for a further 5 minutes. The mixture was extruded in a single screw extruder to obtain dietary fibre pellets (granulated material). The pellets are stored in equilibrium in 65% relative humidity for 5 days. Cylindrical sample bodies were moulded with an injection moulding machine with a clamping force of 50 tons. Injection moulding took place with a screw barrel temperature of 120° C., a tool temperature of 15° C. and an injection pressure of 1500 bar. The holding pressure and holding time were 1000 bar and 30 s respectively. The cylindrical samples obtained had good mechanical properties.

### Exemplary Embodiment 6

The water-soluble fraction (1) was combined with polylactic acid (PLA) for the production of composite films. For this purpose, PLA was first plasticised with 10% polyethylene glycol (part A). At the same time, 65% of the water-soluble fraction (1) was mixed with 25% glycerin and 10% water (part B). These two components were then co-extruded using two single screw extruders to produce a film of type A-B-A. The final composite film consisted of 30% part A and 70% part B. The composite film had a thickness of 1.6 mm and demonstrated good mechanical resistance and elongation of more than 50%.

### Exemplary Embodiment 7

The water-soluble fraction (1) was used as a coating for paper. For this purpose, a 5% solution of the water-soluble fraction (1) was prepared in demineralised water (50° C.) with constant stirring (500 rpm). After complete dissolution, the solution was cooled to room temperature. The paper substrate consisted entirely of primary fibres (mixture of hardwood and softwood) with a grammage of 70 g/m2, a caliper of 95 μm and a paper density of 0.75 g/cm3. Coating was carried out using a laboratory drawdown coater with a coating load weight of 5 g/m2 (single-sided application). Two layers of the coating solution were applied to the paper substrate. The speed of the coating machine was 5 m/min, and the wet film thickness for the first and second layers was 50 μm. The coated paper samples were dried with hot air at 150° C. for 60 s. The coating with the water-soluble fraction (1) improved fat resistance, reduced water vapour permeability, and reduced the permeation of volatile compounds. Consequently, the use of the water-soluble fraction (1) for the coating contributed to the improvement of the barrier properties of cardboard.

### Sources

1. Silva AO, Cortez-Verga WR, Prentice C, Fonseca GG. Development and characterization of biopolymer films based on bocaiuva (Acrocomia aculeata) flour. International Journal of Biological Macromolecules. 2020; 155:1157-1168.
2. AOAC International. (2000). Method 991.43 Total dietary fiber. Enzymatic-gravimetric method. In Official methods of analysis of the association of official analytical chemists (edition 17th). Gaitherburg, MD, USA: Association of Official Analytical Chemists.
3. AOAC International. Method 968.06 Protein (crude) in animal feed. Dumas Method. In Official Methods of Analysis of the Association of Official Analytical Chemists, edition 15th; Association of Official Analytical Chemists: Arlington, VA, USA, 1990.
4. AOAC International. Method 979.09 Protein in grains. Official methods of analysis, 16th ed. Washington DC, USA: Association of Official Analytical Chemists, 1995. 109 p.
5. AOAC International. Method 920.39 Fat (crude) or Ether Extract. In Official Methods of Analysis of the Association of Official Analytical Chemists, edition 15th; Association of Official Analytical Chemists: Arlington, VA, USA, 1990.
6. German Food Act. (1980). Methods L.01.00-60, L. 16.01-2, L. 17.00-1, L. 17.00-3, 1980. In BVL Bundesamt fuer Verbraucherschutz and Lebensmittelsicherheit [Federal Office for Consumer Protection and Food Safety]. Berlin, Germany: Beuth Verlag GmbH. Official collection of methods of analysis according to § 64 Lebensmittel-und Futtermittelgesetzbuch (German Food and Feed Act, LFGB), § 35 vorläufiges Tabakgesetz (German Preliminary Tobacco Act, VTabakG) and § 28b Gentechnikgesetz (German Act on Genetic Engineering, GenTG).

1. Moulding or coating, which contains at least one biopolymer or which is made from at least one biopolymer,
characterized in that
the biopolymer is a dietary fibre preparation which is produced from the flesh of macauba fruits, and
has a dietary fibre content of more than 30% by mass, preferably more than 35% by mass, determined according to the AOAC International method 991.43, and
has a fat content of less than 8% by mass.

2. Moulding or coating according to claim 1,
characterized in that
the moulding is a moulding produced by injection moulding, extrusion, calendaring, rotational moulding, foaming, casting or blow moulding.

3. Moulding or coating according to claim 1,
characterized in that
the dietary fibre preparation contains a fraction of alcohol-water soluble substances less than 40% by mass.

4. Moulding or coating according to claim 1,
characterized in that
the dietary fibre preparation has a fat content of less than 5% by mass.

5. Moulding or coating according to claim 1,
characterized in that
the dietary fibre preparation contains a fraction of alcohol-water-soluble substances and fat of less than 61% by mass in total.

6. Moulding or coating according to claim 1,
characterized in that
the dietary fibre preparation has a dietary fibre content of more than 40% by mass.

7. Moulding or coating according to claim 1,
characterized in that
the dietary fibre preparation has a dietary fibre content of more than 80% by mass.

8. Moulding or coating according to claim 1,
characterized in that
the dietary fibre preparation has a dietary fibre content of water-soluble dietary fibres more than 50% by mass.

9. Moulding or coating according to claim 1,
characterized in that
the moulding or coating additionally contains one or more fractions of macauba fruit flesh, each of which has a dietary fibre content of water-insoluble dietary fibres more than 50% by mass.

10. Moulding or coating according to claim 1,
characterized in that
the dietary fibre preparation has a shell content of less than 10% by mass, relative to the dry matter.

11. Moulding or coating according to claim 1,
characterized in that
the moulding or coating contains the dietary fibre preparation as the main component.

12. (canceled)

13. Moulding or coating according to claim 1,
characterized in that
the moulding is constructed as a film.

14. Moulding or coating according to claim 13,
characterized in that
the film is transparent and contains no plasticisers.

15. Moulding or coating according to claim 13,
characterized in that
the film is furnished with one or more organic and/or inorganic layers.

16. Moulding or coating according to claim 1,
characterized in that
the moulding or coating is constructed as edible packaging or as foodstuff coating.

17. Moulding or coating according to claim 1,
characterized in that
the coating applied as a layer in a composite material that contains paper or cardboard.

18. Method for producing a dietary fibre preparation as biopolymer for a moulding or coating according to claim 1, with at least the following steps:
Providing full fat or partially de-oiled pulp from macauba fruits with a fat content between 3% by mass and 60% by mass relative to dry matter; and
Reducing the fat content in the pulp to a value less than 8% by mass with the aid of one or more extraction methods, if the fat content of the partially de-oiled pulp is greater.

19. Method according to claim 18,
characterized in that
a content of alcohol-water soluble substances in the pulp is reduced with the aid of dry fractionation or one or more extraction methods to such an extent that a content of alcohol-water soluble substances and fat totalling less than 61% by mass is obtained.

20. Method according to claim 18,
characterized in that
a content of alcohol-water soluble substances is reduced by an aqueous extraction with subsequent precipitation to values less than 40% by mass relative to the dry matter, to obtain a water-soluble dietary fibre preparation after drying, to enable its use directly to produce the moulding or coating without drying.

21. Method according to claim 18,
characterized in that
a content of alcohol-water soluble substances is reduced by one or more extraction methods or by dry fractionation to values less than 40% by mass relative to the dry matter, and subsequently either an aqueous extraction, a precipitation with alcohol and a drying are performed to obtain a water-soluble dietary fibre preparation, or an aqueous extraction and a precipitation with alcohol are performed to enable its use directly to produce the moulding or coating without drying.

22. Method according to claim 20,
characterized in that
the content of alcohol-water soluble substances is reduced to a value less than 30% by mass.

23. (canceled)

24. Method according to any claim 18,
characterized in that
the fat content in the pulp is reduced to a value less than 5% by mass.

25. Method according to claim 18,
characterized in that
a fraction of fat and alcohol-water soluble substances is separated simultaneously out of the pulp with one or more mixtures of ethanol and water in a mass ratio from 94:6 to 80:20 at temperatures from 40-70° C.

26. Method according to claim 25,
characterized in that
a further reduction of the content of fat and alcohol-water soluble substances in the pulp is effected by using water and/or one or more mixtures of alcohol and water in a mass ratio of less than 90:10, and at a temperature between 40 and 90° C.

27. (canceled)

28. Method according to claim 18,
characterized in that
the pulp is provided with a shell content of less than 10%, relative to the dry matter, and an endocarp and kernel content of less than 3% by mass relative to the dry matter.

29. Method according to claim 20,
characterized in that
a second fraction of water-insoluble components remaining after the aqueous extraction is provided as a water-insoluble dietary fibre preparation.

30. Method according to claim 20,
characterized in that
a second fraction of water-insoluble components remaining after the aqueous extraction is separated using NaOH-EDTA solution with 0.05-0.1 mol/L NaOH or sodium carbonate and 0.5 mmol EDTA or CDTA or 0.5% (m/v) ammonium oxalate solution into a soluble third fraction and an insoluble fourth fraction, and the third fraction is subsequently dried and undergoes an alcohol precipitation.

31. Method according to claim 30,
characterized in that
the fourth fraction is separated using concentrated alkali into a fifth fraction that is soluble in the alkali and a sixth fraction that is insoluble in the alkali, and the fifth fraction is neutralised and dried or undergoes an alcohol precipitation.

32. (canceled)
